(19) United States
(12) Patent Application Publication
(10) Pub. No.: US 2006/0114513 A1
(43) Pub. Date: Jun. 1, 2006

(54) Gradation correction apparatus and gradation correction method

(75) Inventor: Yoshihiko Ogawa, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/289,613

(22) Filed: Nov. 30, 2005

(30) Foreign Application Priority Data
Nov. 30, 2004 (JP) 2004-347803

(51) Int. Cl. H04N 1/405

(52) U.S. Cl. 358/3.13

(57) ABSTRACT

In a display device, a plurality of display pixels respectively structured from a plurality of display elements is arranged in a matrix form. An arranging circuit outputs image data of R, G, and B in order. A dither pattern generator generates respective pattern data structuring a dither pattern. An Adder respectively adds adjacent pattern data on the dither pattern to input image data corresponding to the display elements adjacent to one another, and provides higher-order bits of a predetermined number in the added values as gradation-corrected image data.

### CROSS-REFERENCE TO RELATED APPLICATIONS

This application is based upon and claims the benefit of priority from prior Japanese Patent Application No. 2004-347803, filed Nov. 30, 2004, the entire contents of which are incorporated herein by reference.

### BACKGROUND OF THE INVENTION

1. Field of the Invention

The present invention relates to a gradation correction apparatus which corrects the gradient of an image display device by using halftone processing.

2. Description of the Related Art

In a digital image display device such as a PDP (plasma display) or an LCD (liquid crystal panel display), there is a limit to the gradations which can be displayed. Accordingly, a halftone display such as a dither method, an error diffusion method, or the like is generally used as a method for apparently increasing the gradations of a display device.

In a dither method, a dither pattern of, for example, 4×4 elements is repeatedly applied onto an entire surface of an input image frame, and pattern data on the dither pattern and corresponding input pixel data are added. Higher-order bit data of the number of bits corresponding to the gradient of the display device (the number of bits less than the number of bits of the input image data) in the added results are provided as gradation-corrected image data to the display device. In accordance therewith, the gradient is improved in units of a region corresponding to the dither pattern of the display device. The details of a dither method are disclosed in, for example, Jpn. Pat. Appln. KOKAI Publication No. 2002-359845 (FIG. 1, FIG. 2). As in this Jpn. Pat. Appln. KOKAI Publication No. 2002-359845, a dither method is used for preventing a moire phenomenon brought about due to the correlativity of quantization noise by quantization processing.

An error diffusion method is, for example, as shown in Jpn. Pat. Appln. KOKAI Publication No. 2003-169212 (FIG. 1, FIG. 2), a method in which image data which is a processing object is converted into a pixel signal whose number of bits is less than the number of bits at the time of quantization, and an error generated by the bit conversion is added to a pixel signal which is the following processing object, thereby diffusing the error. As shown in Jpn. Pat. Appln. KOKAI Publication No. 2003-169212, an error diffusion method carries out a halftone display by distributing an error component generated in a pixel to, for example, four pixels at the periphery of the pixel.

In the dither method, the quality of a halftone display is determined by a size of a dither pattern (the number of pattern data) and a region size on a display screen to which the dither pattern is applied. A finer halftone display is possible in a case in which a size of a dither pattern is larger. However, accompanying the enlargement in a size of a dither pattern, a region size on a display screen to which the dither pattern is applied is made larger. The larger the region size to which the dither pattern is applied is, the easier the dither pattern can be visually recognized on the display screen, which is undesirable.

In an error diffusion method, a finer halftone display is possible in a case in which the number of peripheral pixels to which an error is diffused is greater. However, accompanying the increase in the number of peripheral pixels to which an error is diffused, a region (diffusion region) size on a display screen to which the error is diffused is made larger. The larger the diffusion region size is, the easier the diffusion region can be visually recognized on the display screen, which is undesirable.

### BRIEF SUMMARY OF THE INVENTION

In a conventional method as described above, halftone processing is carried out in units of a pixel. In a dither method, a region size to which one dither pattern is applied is determined on the basis of a pixel size. In an error diffusion method, a range to which an error is diffused is determined in accordance with a pixel size. In a display device such as a PDP, an LCD, or the like, one pixel is structured from three display elements of R (red), G (green), and B (blue).

Then, in the present embodiment, halftone processing which is carried out in units of a pixel in the conventional art is carried out in units of each display element of R, G, B serving as a minimum unit for processing. In this manner, for example, in a case of a dither method, a region size on a display screen to which one dither pattern is applied can be made significantly smaller than that in the conventional method. Thus, it is possible to minutely control the gradient, and the performance of halftone processing can be improved. In a case of an error diffusion method as well, since the diffusion range is made significantly smaller even if an error is diffused in the same way as in the conventional method, the effect of halftone processing can be improved. Namely, the quality in a halftone display by using a dither method or an error diffusion method is improved.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a first embodiment of a gradation correction apparatus according to the present invention;

FIGS. 2A, 2B and 2C are diagrams for explanation in detail of dither processing according to the first embodiment;

FIG. 3 is a diagram showing a range to which a dither matrix is applied in a conventional art;

FIG. 4 is a diagram showing a range to which a dither matrix is applied in the present invention;

FIG. 5 is a schematic block diagram showing a second embodiment of the present invention;

FIG. 6 is a schematic block diagram showing a third embodiment of the present invention;

FIG. 7 is a diagram showing an image frame for explanation of the brief of error diffusion processing; and

FIG. 8 is a schematic block diagram showing a fourth embodiment of the present invention.

### DETAILED DESCRIPTION OF THE INVENTION

Hereinafter, embodiments of the present invention will be described in detail with reference to the drawings.

### FIRST EMBODIMENT

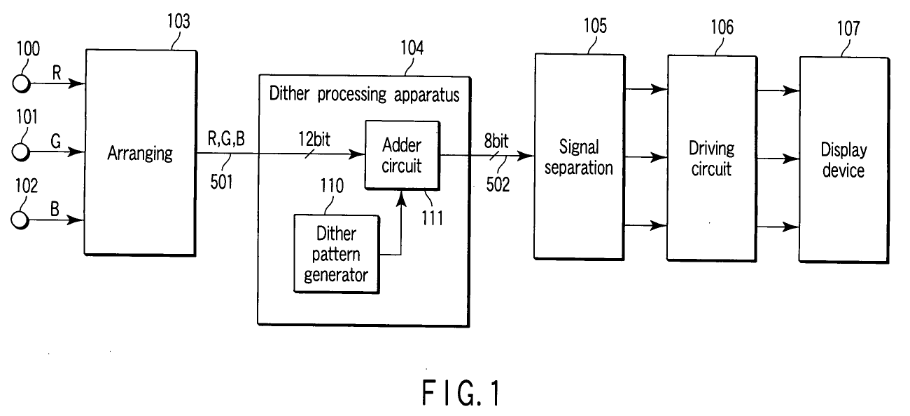

FIG. 1 is a block diagram showing a first embodiment of a gradation correction apparatus according to the present invention.

Terminals 100 to 102 are signal input parts into which signals of R (red), G (green), and B (blue) to be displayed on a display device are inputted in parallel. The signals of R, G, and B inputted from these terminals are inputted to an arranging circuit 103. The arranging circuit 103 arranges the input three signals into an arrangement which is the same as the arrangement of display elements of a display device 107, and outputs the R, G, and B signals (image data 501) in order. For example, when the display elements of the display device are arranged from the left to the right in the order of R, G, and B . . . , the image data 501 are outputted in the order of R, G, and B . . . in the same way. The image data 501 outputted from the arranging circuit 103 are inputted to a dither processing apparatus 104.

The dither processing apparatus 104 includes a dither pattern generator 110 and an adder circuit 111. The image data 501 outputted from the arranging circuit 103 is supplied to an input terminal at one side of the adder circuit 111. An output signal from the dither pattern generator 110 is supplied to an input terminal at the other side of the adder circuit 111. The dither pattern generator 110 outputs respective pattern data of the dither pattern in accordance with the positions of the R, G, and B signals inputted to the dither processing apparatus 104. The adder circuit 111 adds two input signals to be outputted. An output from the adder circuit 111 is an output from the dither processing apparatus 104.

The output signal from the dither processing apparatus 104 is inputted to a signal separating circuit 105. In the signal separating circuit 105, respective pixels are separated (extracted) from the three signals of R, G, and B provided in the order by the arranging circuit 103, and the three signals of R, G, and B are simultaneously outputted. The three signals of R, G, and B outputted form the signal separating circuit 105 are inputted to the display device 107 via a driving circuit 106.

The display device 107 includes a display screen such as a PDP, an LCD, or the like, and the display screen is structured from a plurality of scanning lines respectively including a plurality of display pixels. The driving circuit 106 outputs R, G, and B signals to the display device 107 in units of image data corresponding to one scanning line of the display screen. The display device 107 displays a color image on the basis of R, G, and B signals in each scanning line supplied from the driving circuit 106.

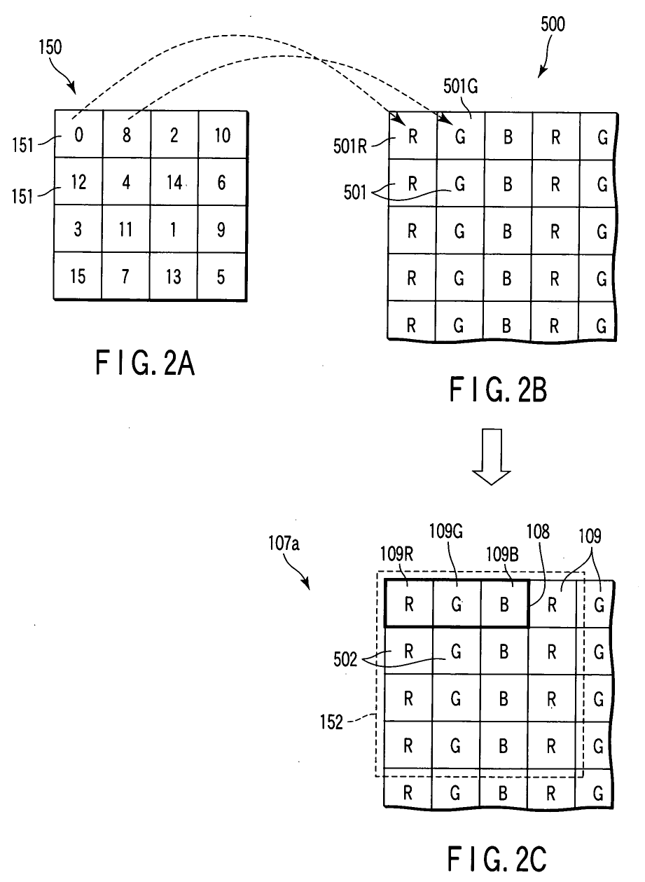

FIGS. 2A, 2B and 2C are diagrams for explanation in detail of dither processing according to the present embodiment.

FIG. 2A shows a dither pattern 150 which the dither pattern generator 110 has, and FIG. 2B shows an image frame 500 structured from input image data 501, and FIG. 2C is a display screen 107a of the display device 107.

In the display screen 107a, display pixels 108 are arranged in a matrix form. The display pixels 108 are formed from display elements 109R displaying red, display elements 109G displaying green, and display elements 109B displaying blue. Here, an example in which the resolution of each input image data 501 of R, G, and B is 12 bits, and the resolution of each display element 109 of the display device 107 is 8 bits will be described.

The 12-bit input image data 501 are converted into 8-bit image data 502 whose gradient has been corrected, by the dither processing apparatus 104. The resolution (8 bits) of the image data 502 is a resolution which is the same as that of the display element 109. The dither pattern 150 is structured due to a plurality of pattern data 151 being arranged in a matrix form. The number of bits (resolution) of the pattern data 151 is the number of bits (4 bits) which is the same as a difference between the number of bits (12 bits) of the input image data 501 and the number of bits (8 bits) of the display element 109. Namely, given that the resolution of the display element 109 is L bits, and the resolution of the input image data 501 (each of R, G, and B signals) is M bits, the pattern data 151 is data expressed by M-L bits.

In the dither pattern 150, the pattern data 151 from 0 (=0000b) to 15 (=1111b) are arranged (b denotes a binary number). Note that all the pattern data 151 arranged in the dither pattern 150 are numeric values different from one another, and the same data are not arranged.

The dither pattern 150 is repeatedly applied onto the entire surface of the image frame 500, and the pattern data on the dither pattern and the corresponding image data 501 are added. Higher-order bit data (8 bits) of the number of bits corresponding to the gradient of the display device 107 (the number of bits less than the number of bits of the image data 501) in the added results are provided as gradation-corrected image data 502.

The image data 502 are, as described above, provided to the corresponding display elements 109 in the display screen 107a by the signal separating unit 105 and the driving circuit 106. Namely, the image frame 500 is reappeared on the display screen 107a by the signal separating unit 105 and the driving circuit 106. Accordingly, the arrangement of the R, G, and B image data in the image frame 500 is the same as the arrangement of the R, G, and B display elements 109 in the display screen 107a.

Namely, the adder circuit 111 adds, for example, image data 501R and corresponding pattern data “0” on the dither pattern 150, and higher-order bits (8 bits) of the number corresponding to the number of bits of the display element 109 in the added values are provided as gradation-corrected image data 109R. Further, the adder circuit 111 adds the image data 501G and corresponding pattern data “8” on the dither pattern 150. In other words, the adder circuit 111 respectively adds adjacent pattern data on the dither pattern 150 (“0” and 8) to the image data (501R and 501G) corresponding to the adjacent display elements (for example, 109R and 109G). The adder circuit 111 provides higher-order bits (8 bits) of the number corresponding to the number of bits of the display element 109 in the respective added values as gradation-corrected image data 109G.

In this way, dither processing is applied to the signals inputted from the terminals 100 to 102, and the signals are displayed on the display device 107. The dither processing at this time is carried out with respect to the signals 501 arranged in accordance with the arrangement of the display elements 109 of the display device. Namely, the dither processing according to the present embodiment is carried out in units of a display element.

In accordance with the dither processing, the resolution of the respective display elements 109 is 8 bits. However, focusing on a region 152 corresponding to the dither pattern 150 of the display device 107, an image is displayed at a resolution of 9 bits. Namely, the gradient is improved in units of the region 152 corresponding to the dither pattern 150 of the display screen 107a.

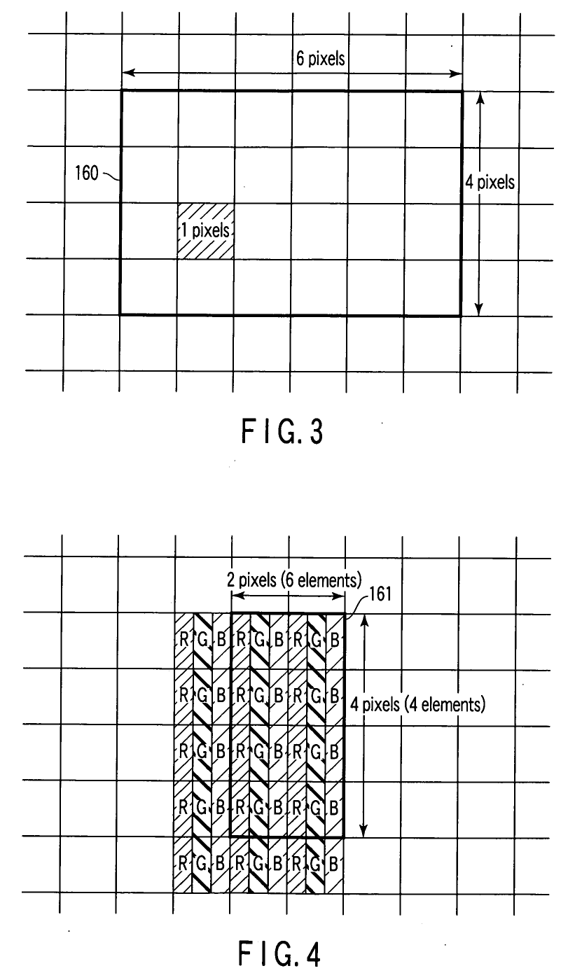

Next, a difference between an image obtained by the dither processing according to the present embodiment and an image obtained by the conventional dither processing will be described. Here, as an example, a dither matrix of 6×4 as shown in FIG. 3 will be considered.

In the conventional method, the dither processing is carried out separately with respect to each color in units of a pixel. For example, when the dither processing is carried out with respect to an R signal, as shown in FIG. 3, a range 160 to which the dither matrix 150 is applied is a range of 6×4 pixels. The same applies to a G signal and a B signal.

In the present embodiment, R, G, and B are not distinguished, and the processing is carried out in units of the display elements 109 of the display device 107. Accordingly, a range to which the dither matrix 150 is applied is, as shown by a range 161 in FIG. 4, 6×4 elements, i.e., 2×4 pixels. In this way, a region size on the screen to which one dither matrix is applied can be made smaller than that in the conventional method. Namely, in accordance with the present embodiment, even if a dither matrix which is the same as that in the conventional method is used, a region size to which the matrix is applied can be made small. Accordingly, fine gradation expression is possible, which makes a pattern of the dither matrix hard to see on the screen of the display device.

### SECOND EMBODIMENT

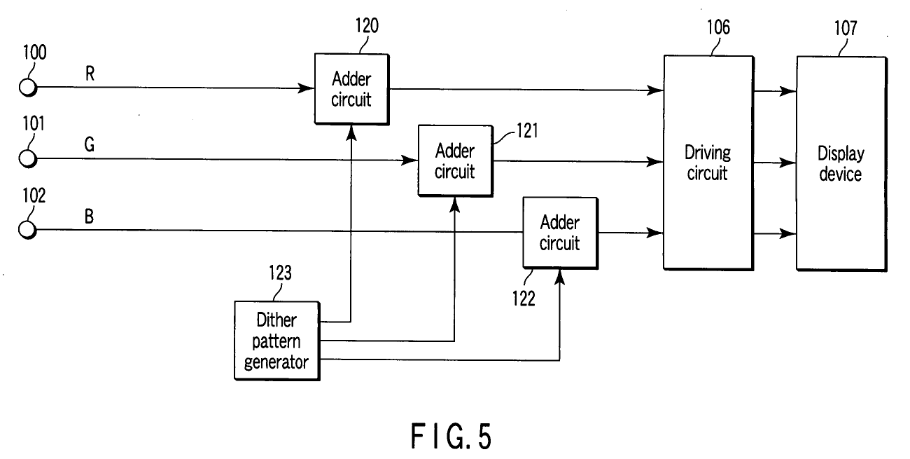

A second embodiment of the present invention will be described in FIG. 5. Portions which are the same as those in FIG. 1 are denoted by the same numbers, and descriptions thereof will be omitted.

In the first embodiment, three signals are arranged, and the processing is carried out with respect to each of the signals in order. However, in the present embodiment, arranging is not carried out, and the three signals are processed simultaneously (in parallel).

The signals inputted in parallel from terminals 100 to 102 are respectively supplied to input terminals at sides of adder circuits 120 to 122. A dither pattern generator 123 generates dither pattern data. Pattern data outputted from the dither pattern generator 123 are inputted to input terminals at the other sides of the respective adder circuits 120 to 122.

The pattern data outputted from the dither pattern generator 123 are continuous values on a dither pattern which are different from one another. For example, in a case of a dither pattern 150 as shown in FIG. 2A, three data such as 0, 8, 2 in the upper left are simultaneously outputted from the dither pattern generator 123 with respect to the image data R, G, and B. In a conventional dither pattern generator, because the processing is carried out with respect to the signals inputted in order, the data of the dither pattern are outputted one by one in the timings of the data to be inputted. In the case of the present embodiment, the pattern data of the dither pattern are simultaneously outputted with respect to the three input image data of R, G, and B.

At that time, it is determined that which data in the dither pattern is outputted with respect to which input image data, in accordance with an arrangement of display elements 109 of a display device 107. For example, suppose that the display elements of the display device are arranged in the order of R, G, and B. Then, suppose that the dither pattern is arranged in the order of pattern data A, pattern data B, pattern data C, pattern data D, and . . . . In this case, the pattern data A, the pattern data B, and the pattern data C are respectively added to an input R signal, an input G signal, and an input B signal simultaneously by the adder circuits 120 to 122. With respect to a pixel to be inputted next, the pattern data D is added to an R signal, and the pattern data A is added to a G signal, and hereinafter, the same processing continues.

All the signals to which the dither pattern data are added by the adder circuits 120 to 122 are inputted to the driving circuit 106. Operations on and after the driving circuit 106 are the same as those in the first embodiment.

In the case of the present embodiment as well, in the same way as in the first embodiment of FIG. 1, dither processing is carried out in units of display elements of the display device. Accordingly, because a range to which one dither matrix is applied can be made smaller than that in the conventional method, fine gradation expression is possible, which makes a pattern of the dither matrix hard to see on the screen of the display device. Moreover, in the dither processing in accordance with the present embodiment, because three input signals are simultaneously processed, the image processing speed is higher than that in the first embodiment.

### THIRD EMBODIMENT

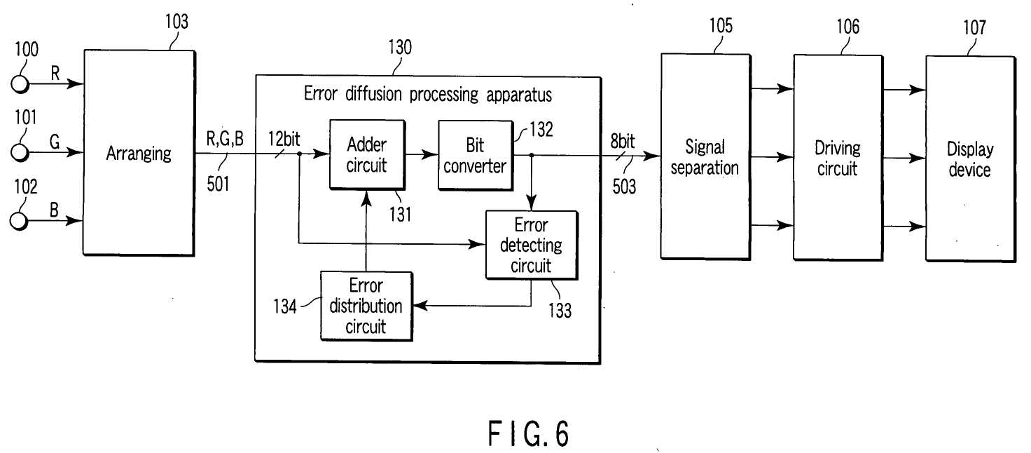

A third embodiment is shown in FIG. 6. Components which are the same as those in FIG. 1 are denoted by the same numbers, and description thereof will be omitted.

The present embodiment is an example in which the present invention is applied to error diffusion processing.

Image data 501 outputted from an arranging circuit 103 are inputted to an error diffusion processing circuit 130. The error diffusion processing circuit 130 is structured from an adder circuit 131, a bit converter 132, an error detecting circuit 133, and an error distribution circuit 134.

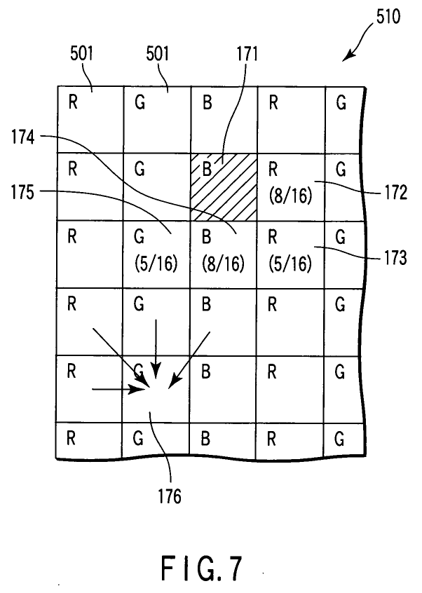

FIG. 7 is a diagram showing an image frame 510 for explanation of the brief of error diffusion processing. The image frame 510 is structured from input image data 501. Suppose that the arrangement of image data of R, G, and B in the image frame 510 corresponds to the arrangement of display elements 109 of R, G, and B which are formed on a display screen 107a as shown in FIG. 2. In the present example, a conversion error E in bit conversion processing of input image data corresponding to an arbitrary display element 171 is added (diffused) to peripheral four display elements 172 to 175. In FIG. 7, 8/16 of the error E is added to the image data of the display element 172, 5/16 thereof is added to the image data of the display element 173, 8/16 thereof is added to the image data of the display element 174, and 5/16 thereof is added to the image data of the display element 175. Such processing in which a bit conversion error is added to peripheral display elements at a predetermined rate is carried out with respect to all display elements. As a result, the sum of bit conversion errors generated at the peripheral elements is added to each display element as a display element 176.

The description of FIG. 6 will be continued. The image data 501 from the arranging circuit 103 are inputted to the adder circuit 131 and the error detecting circuit 133. In the adder circuit 131, error components of the peripheral elements outputted from the error distribution circuit 134 are added and outputted. An output from the adder circuit 131 is inputted to the bit converter 132. In the bit converter 132, the number of bits of the input signal is converted, and the signal is outputted. The bit converter 132 outputs, for example, the higher-order 8 bits of the input 12-bit data.

The output signal from the bit converter 132 is outputted as an output signal of the error diffusion processing circuit 130, and is inputted to the error detecting circuit 133. In the error detecting circuit 133, a detection of an error amount generated by the bit conversion processing carried out at the bit converter 132 is carried out on the basis of the input signal of the error diffusion processing circuit 130 and the output signal from the bit converter 132. An error signal showing the detected error amount is outputted from the error detecting circuit 133, and is inputted to the error distribution circuit 134. In the error distribution circuit 134, the error amount detected at the time of converting the bits of certain image data is distributed to peripheral pixels at specific rates respectively. Namely, the error distribution circuit 134 outputs the sum of the error amounts distributed from pixels at the periphery of a target pixel to the target pixel to the adder circuit 131. The adder circuit 131 adds the input image data 501 of the error diffusion processing circuit 130 and the sum of the error amounts from the error distribution circuit 134.

The output from the bit converter 132 is inputted to a signal separating circuit 105 as an output from the error diffusion processing circuit 130. Operations on and after the signal separating circuit 105 are the same as those in the first embodiment.

In the conventional error diffusion processing, because the processing is carried out with respect to each color signal of R, G, and B separately in units of one pixel size, an error component generated in a certain pixel is distributed to peripheral pixels thereof. For example, when error diffusion processing is carried out with respect to R signals, an error component in R of a target pixel is distributed to R signals of peripheral pixels thereof. Namely, an error component of a certain color signal of a target pixel is distributed to the same color signals of peripheral pixels thereof. The same applies to G signals and B signals.

In the present embodiment, R, G, and B are not distinguished, and the processing is carried out in units of display elements of the display device. Accordingly, an error component of a target display element, for example, an R display element is distributed to R, G, and B display elements at the periphery thereof. Therefore, a region to which an error is distributed is made smaller than that in the conventional case in which processing is carried out in units of pixels, which makes the diffusion region hard to see on the screen of the display device. Namely, fine gradation expression is possible in accordance with the present embodiment.

### FOURTH EMBODIMENT

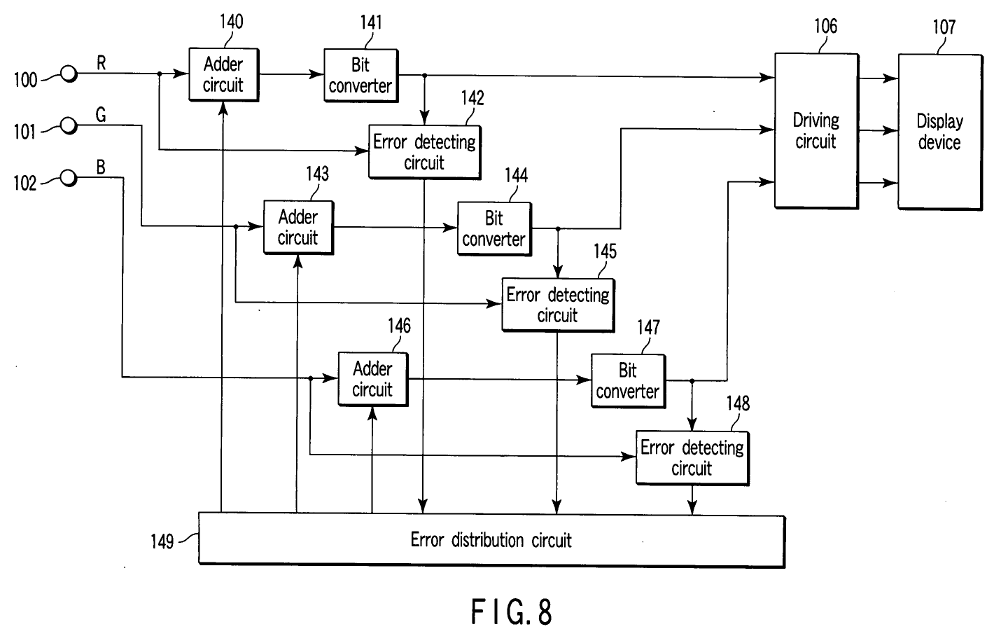

A fourth embodiment is shown in FIG. 8. Components which are the same as those in FIG. 1 are denoted by the same numbers, and descriptions thereof will be omitted.

In the above-described third embodiment, the three signals inputted in parallel are arranged, and the error diffusion processing is carried out with respect to each of the signals in order. However, in the present embodiment, arranging is not carried out, and the error diffusion processing is carried out simultaneously (in parallel) with respect to the three signals.

Image data inputted in parallel from terminals 100 to 102 are respectively supplied to input terminals at sides of adder circuits 140, 143, and 146. Error components outputted from an error distribution circuit 149 are inputted to input terminals at the other sides of the respective adder circuits 140, 143, and 146. The error components inputted to the adder circuits 140, 143, and 146 are data which are different from one another.

An output from the adder circuit 140 is inputted to a bit converter 141. In the bit converter 141, the number of bits of the input signal is converted, and the signal is outputted. The bit converter 141 outputs, for example, the higher-order 8 bits of the input 12-bit data. The output from the bit converter 141 is inputted to a driving circuit 106, and is inputted to an error detecting circuit 142. In the error detecting circuit 142, a detection of an error signal generated by bit conversion processing carried out at the bit converter 141 is carried out on the basis of the input signal from the terminal 100 and the output signal from the bit converter 141. Namely, the error detecting circuit 142 outputs a difference between the two input signals as an error signal. The error signal outputted from the error detecting circuit 142 is inputted to the error distribution circuit 149.

In the same way as described above, the output from the adder circuit 143 is inputted to a bit converter 144, and the number of bits is converted. The output from the bit converter 144 is inputted to the driving circuit 106, and is inputted to an error detecting circuit 145. In the error detecting circuit 145, a detection of an error signal generated by the bit conversion processing carried out at the bit converter 144 is carried out. The detected error signal is inputted to the error distribution circuit 149.

In the same way, the output from the adder circuit 146 is inputted to a bit converter 147, and the number of bits is converted. The output from the bit converter 147 is inputted to the driving circuit 106, and is inputted to an error detecting circuit 148. In the error detecting circuit 148, a detection of an error signal generated by the bit conversion processing carried out at the bit converter 147 is carried out. The detected error signal is inputted to the error distribution circuit 149.

The error distribution circuit 149 distributes the detected error signal to peripheral pixels at a specific rate as shown in FIG. 7. The distribution at this time is carried out in units of display elements 109 of the display device. Namely, because an error component of each element 109 of the display device is inputted from the error detecting circuits 142, 145, and 148, the error distribution circuit 149 carries out the distributions of those error components with respect to each element 109. Then, the sum of the error components distributed from the peripheral elements is outputted with respect to each element. The outputs are added to the input signals by the adder circuits 140, 143, and 146.

In accordance with the present embodiment, in the same way as in the case of the third embodiment of FIG. 6, because the processing can be carried out in units of display elements of the display device, a region to which an error is distributed is made smaller than in the case in which processing is carried out in units of pixels, which is hard to see on the screen of the display device. Namely, fine gradation expression is possible in accordance with the present embodiment. Moreover, in the error diffusion processing in accordance with the present embodiment, because three input signals are simultaneously processed, the image processing speed is higher than that in the third embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gradation correction apparatus which corrects gradation of a display device in which a plurality of display pixels respectively structured from a plurality of display elements is arranged in a matrix form, the gradation correction apparatus comprising:
an input unit to which image data expressed by a predetermined number of bits to display the display elements are inputted;
a generator unit which generates respective pattern data structuring a dither pattern; and
an adder unit which respectively adds adjacent pattern data on the dither pattern to the image data corresponding to the display elements adjacent to one another, and which provides higher-order bits of the number less than the predetermined number in the respective added values as gradation-corrected image data.

2. The gradation correction apparatus according to claim 1, wherein
the input unit has an arranging unit which inputs R, G, and B signals in parallel, and which provides the input R, G, and B signals in an arrangement corresponding to an arrangement of the display elements in order, and
the adder unit respectively adds pattern data which are generated from the generator unit and are different from one another in order, to each of R, G, and B signals provided from the arranging unit, and outputs predetermined higher-order bits of the added values as gradation-corrected R, G, and B signals in order,
the gradation correction apparatus further comprising a conversion unit which converts the R, G, and B signals outputted from the adder unit into parallel R, G, and B signals.

3. The gradation correction apparatus according to claim 1, wherein
the input unit provides the R, G, and B signals in parallel,
the generator unit outputs three pattern data continuously arranged on the dither pattern in parallel, and
the adder unit respectively adds the input R, G, and B signals and the three pattern data generated by the generator unit, and provides gradation-corrected R, G, and B signals in parallel.

4. The gradation correction apparatus according to claim 2, wherein, given that resolutions of the display elements are L bits, and resolutions of the input R, G, and B signals are M bits, the pattern data are data expressed by “M-L” bits.

5. A gradation correction apparatus which corrects gradation of a display device in which a plurality of display pixels respectively structured from a plurality of display elements is arranged in a matrix form, the gradation correction apparatus comprising:
an input unit to which image data expressed by a predetermined number of bits to display the display elements are inputted, and which provides input image data;
an error diffusion processing unit which converts the input image data corresponding to an arbitrary one of the display elements into image data whose number of bits is less than the predetermined number, and which provides gradation-corrected image data by adding an error amount generated at the time of the conversion to input image data corresponding to peripheral display elements adjacent to the arbitrary display element at specific rates respectively.

6. The gradation correction apparatus according to claim 5, wherein
the input unit has an arranging unit which inputs R, G, and B signals in parallel, and which provides the input R, G, and B signals in an arrangement corresponding to an arrangement of the display elements in order, and
the error diffusion processing unit carries out the error diffusion processing in order with respect to the R, G, and B signals provided from the arranging unit.

7. The gradation correction apparatus according to claim 5, wherein the input unit inputs R, G, and B signals in parallel, and the error diffusion processing unit carries out the error diffusion processing in parallel with respect to the R, G, and B signals inputted in parallel.

8. A method for correcting gradation of a display device in which a plurality of display pixels respectively structured from a plurality of display elements is arranged in a matrix form, the gradation correction method comprising:
inputting image data expressed by a predetermined number of bits to display the display elements;
generating respective pattern data which structures a dither pattern; and
respectively adding adjacent pattern data on the dither pattern to the image data corresponding to the display elements adjacent to one another, and of providing higher-order bits of the number less than the predetermined number in the added values as gradation-corrected image data.

9. The gradation correction method according to claim 8, wherein
the inputting includes inputting R, G, and B signals in parallel, and provides the input R, G, and B signals in an arrangement corresponding to an arrangement of the display elements in order, and
the adding includes adding the respective pattern data to be generated in order, to each of the R, G, and B signals provided in order, and outputs predetermined higher-order bits of the added values as gradation-corrected R, G, and B signals in order,
the gradation correction method further comprising converting the gradation-corrected R, G, and B signals into parallel R, G, and B signals.

10. The gradation correction method according to claim 8, wherein
the inputting includes inputting the R, G, and B signals in parallel, and provides the input R, G, and B signals,
the generating includes outputting three pattern data continuously arranged on the dither pattern in parallel, and
the adding includes adding the input R, G, and B signals and the generated three pattern data, and provides the gradation-corrected R, G, and B signals in parallel.

11. The gradation correction method according to claim 9, wherein, given that resolutions of the display elements are L bits, and resolutions of the input R, G, and B signals are M bits, the pattern data are data expressed by “M-L” bits.
